(19) United States
(12) Patent Application Publication
(10) Pub. No.: US 2025/0196440 A1
(43) Pub. Date: Jun. 19, 2025

(54) EXTRUDER DRIVER GEARS AND RELATED ASSEMBLIES AND METHODS INCLUDING EXTRUDER DRIVER GEARS

(71) Applicant: US Synthetic Corporation, Orem, UT (US)

(72) Inventors: Scott Schmidt, Draper, UT (US); Harris Taylor, Lehi, UT (US)

(21) Appl. No.: 18/979,206

(22) Filed: Dec. 12, 2024

Related U.S. Application Data
(60) Provisional application No. 63/609,464, filed on Dec. 13, 2023.

(51) Int. Cl. B29C 64/321; B23K 26/36; B23K 101/00; B23K 103/00; B29C 64/118; B29C 64/209

(52) U.S. Cl. CPC B29C 64/321; B23K 26/36; B29C 64/118; B29C 64/209; B23K 2101/008; B23K 2103/52

(57) ABSTRACT

Embodiments include extruder driver gears for three-dimensional printing, extruder driver gear assemblies, and methods of forming and using extruder driver gears. An example extruder driver gear includes a hub configured for coupling to a torque transmitting component, a gear body connected to the hub, and a plurality of filament gripping teeth extending radially from the gear body, the plurality of filament gripping teeth comprising a superhard material.

### CROSS-REFERENCE TO RELATED APPLICATIONS

This application claims the benefit of the filing date of U.S. Provisional Patent Application Ser. No. 63/609,464, filed 13 Dec. 2023, for “EXTRUDER DRIVER GEARS AND RELATED ASSEMBLIES AND METHODS INCLUDING EXTRUDER DRIVER GEARS,” the disclosure of which is incorporated herein, in its entirety, by this reference.

### BACKGROUND

Three-dimensional (“3D”) printing, also known as additive manufacturing, is a technology that allows the creation of three-dimensional objects from digital models. It works by adding material layer by layer to build a physical object, as opposed to traditional subtractive manufacturing methods that involve cutting away material from a solid stock.

Methods of three-dimensional printing may include feeding material, in the form of a wire-like filament, with an extruder to a hot end, wherein the material may be melted. The melted material may then be dispensed from a nozzle to form a layer of the material onto a platform. The extruder may include one or more driver gears that grip or engage the filament and feed the filament incrementally into the hot end. During the three-dimensional printing process, the filament may continue to be fed into the hot end by the extruder to provide additional material to be melted and dispensed from the nozzle onto the first and subsequent layers until an object is formed. However, several issues exist with conventional extruders and extruder driver gears, such as excessive wear of the extruder driver gears, slipping of the filament relative to the extruder driver gears, underfeeding of the material to the hot end, excessive size and/or weight of the extruder, time consuming and costly maintenance of the extruder, material waste, 3D printer downtime, relatively slow printing speed, and relatively low dimensional accuracy of the object that is being formed.

### SUMMARY

Embodiments are directed to extruder driver gears for three-dimensional printing, extruder assemblies including the same, and methods of forming and using the same. In an embodiment, an extruder driver gear for three-dimensional printing is disclosed. The extruder driver gear may include a hub configured for coupling to a torque transmitting component, a gear body connected to the hub, and a plurality of filament gripping teeth extending radially from the gear body, the plurality of filament gripping teeth comprising a superhard material.

In an additional embodiment, a three-dimensional printer is disclosed. The three-dimensional printer may include a hot end configured to melt a filament and an extruder configured to feed the filament into the hot end. The extruder may include a motor and an extruder driver gear coupled to the motor, the extruder driver gear comprising a plurality of filament gripping teeth comprising a superhard material.

In a further embodiment, a method of manufacturing an extruder driver gear is disclosed. The method includes forming a precursor structure comprising a superhard material and removing a portion of the superhard material from the precursor structure to form a gear body having a plurality of filament gripping teeth extending from the gear body, the plurality of filament gripping teeth comprising the superhard material.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is a schematic of a portion of a 3D printer including a Bowden tube extrusion system with extruder driver gears comprising a superhard material, according to an embodiment.

FIG. 2 is a schematic of a portion of a 3D printer including a direct extrusion hot end system with an extruder driver gear comprising a superhard material, according to an embodiment.

FIG. 3 is an isometric view of an extruder driver gear comprising a superhard material, according to an embodiment.

FIG. 4 is a cross-sectional view of an assembled extruder driver gear having a gear body and filament gripping teeth made from a superhard material, according to an embodiment.

FIG. 5 is a cross-sectional view of a monolithic extruder driver gear with a hub, gear body, and filament gripping teeth made from a superhard material, according to an embodiment.

FIG. 6 is an isometric view of an extruder driver gear comprising a superhard material and wherein each filament gripping tooth comprises a top land, according to an embodiment.

FIG. 7 is an isometric view of an extruder driver gear comprising a superhard material and with pyramidal filament gripping teeth, according to an embodiment.

FIG. 8 is an isometric view of an extruder driver gear comprising a superhard material with a hub contained within the gear body, according to an embodiment.

FIG. 9 is an isometric view of a set of extruder driver gears with curved filament gripping teeth comprising a superhard material and a hub comprising intermeshing torque transmission gears, according to an embodiment.

FIG. 10 is a schematic illustration of a method for fabricating an extruder driver gear from polycrystalline diamond, according to an embodiment.

### DETAILED DESCRIPTION

The present disclosure relates to one or more extruder driver gears, such as for three-dimensional (3D) printing, extruder assemblies including the same, and methods of forming and using the same. An example extruder driver gear includes a hub configured for attachment to a torque transmitting component, a gear body connected to the hub, and a plurality of filament gripping teeth (e.g., geometric features sized and configured for moving filament in response to rotation of the gear body) extending radially from the gear body, the plurality of filament gripping teeth comprising a superhard material.

In some embodiments, features of the extruder driver gears disclosed herein may be configured to, for example, reduce wear of the extruder driver gears, reduce slipping of a filament relative to the extruder driver gears, prevent underfeeding of the material to the hot end, reduce the size and/or weight of the extruder, reduce time consuming and costly maintenance of the extruder, reduce material waste, reduce 3D printer downtime, increase printing speed, and/or increase dimensional accuracy of the object that is being formed. These features may be useful when any printing material filament is being fed by the extruder but may be especially useful when an abrasive printing material filament is being fed by the extruder. Abrasive printing material filaments may include materials exhibiting a hardness that is comparable to or greater than brass, steel, or other materials that are commonly used to form extruder driver gears. Examples of abrasive printing materials include polymers with one or more hard particles (e.g., ceramic particles, metal particles, carbon fiber, strontium aluminate, etc.) disposed therein, a ceramic, a metal, a composite, or combinations thereof.

In some embodiments, an extruder driver gear disclosed herein may at least partially comprise (or be formed from) at least one of polycrystalline diamond (“PCD”), polycrystalline cubic boron nitride (“PcBN”), or another superhard material. As used herein, the term “superhard material” refers to polycrystalline diamond (“PCD”), polycrystalline cubic boron nitride (“PcBN”), a material exhibiting a hardness that is equal to or greater than tungsten carbide, and/or a combination of any of the foregoing. For example, the extruder driver gears may be formed such that the features of the extruder driver gears disclosed herein, such as the teeth thereof, may be defined by, may comprise, and/or may be formed by PCD, PcBN, or another superhard material (e.g., a material having a hardness that is equal to or greater than that of tungsten carbide).

In some embodiments, the extruder driver gears may include gripping surfaces somewhat similar to those disclosed in any of U.S. Pat. Nos. 7,464,973, 4,629,373, and 11,274,731, the disclosure each of which is hereby incorporated by reference in its entirety. For example, the extruder driver gears may include polycrystalline diamond power transmission surfaces including gears, universal joints, or other power transmission systems or components; surfaces with enhanced surface irregularities; and/or gripping surfaces with traction, anchoring, and/or securing features.

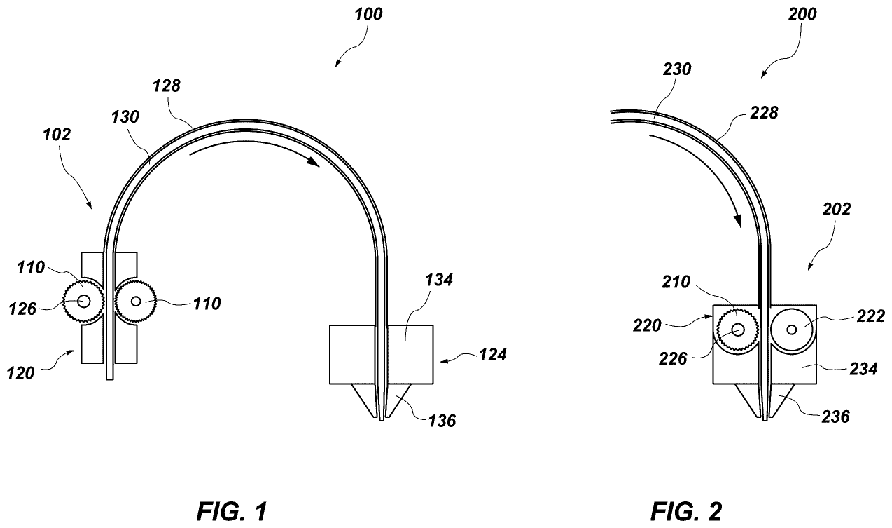

FIG. 1 is a schematic of a portion of a 3D printer 100 including a Bowden tube extrusion system 102 with one or more driver gears (e.g., a set of extruder driver gears 110) comprising a superhard material, according to an embodiment. The one or more driver gears 110 may include as set of two driver gears are depicted. In additional embodiments, one driver gear may be implemented along with an idler gear, as discussed below.

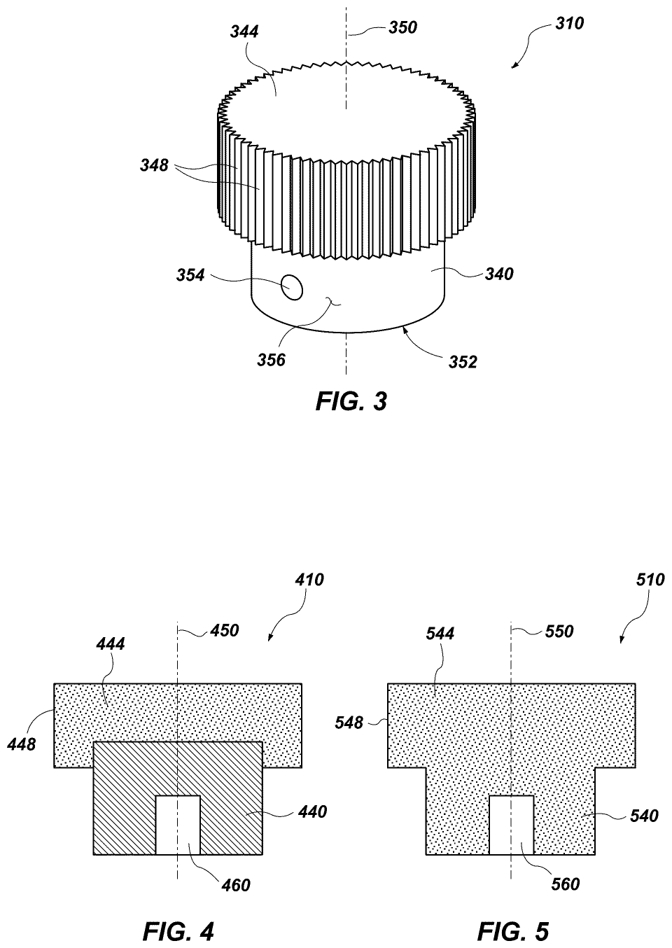

The 3D printer 100 may include an extruder 120, a hot end 124, and a Bowden tube 128 extending from the extruder 120 to the hot end 124. The extruder 120 may include a motor (not shown), such as a stepper motor, and a set of extruder driver gears 110 (e.g., which may include a superhard material as discussed in further detail herein with reference to FIGS. 3-10). A hub of one of the extruder driver gears 110 may be mounted to a drive shaft 126 of the motor such that the motor may selectively apply a torque to one of the extruder driver gears 110 to cause the selective rotation of the extruder driver gears 110. The Bowden tube 128 may be a flexible tube and may be made of materials such as polytetrafluoroethylene (PTFE) or perfluoroalkoxy (PFA), as these materials may be relatively lightweight, flexible, and provide low friction. The hot end 124 may include a heater 134, such as a resistive heating element, and a nozzle 136.

A filament 130 may be provided from a reel (not shown) and extend through the extruder 120 and the Bowden tube 128 (e.g., which spaces the extruder 120 from the nozzle 136) to the hot end 124. Within the extruder 120, a portion of the filament 130 may be positioned between the set of extruder driver gears 110 that may grip or engage the filament 130.

When the 3D printer 100 requires material for forming an object, the motor may be activated and apply a torque to one of the extruder driver gears 110 and cause the extruder driver gears 110 to rotate. Teeth of the extruder driver gears 110 may grip or engage the outer surface of the filament 130 and cause the filament to advance through the extruder 120, through the Bowden tube 128, and into the hot end 124 in response to the rotation of the extruder driver gears 110. The end of the filament 130 may then be melted in the hot end 124 by the heater 134 and the resulting molten material may be pushed out of the hot end 124 through the nozzle 136 with pressure being applied to the molten material by the filament 130 being fed into the hot end 124 by the set of extruder driver gears 110 of the extruder 120.

As the molten material exits the nozzle 136, the hot end 124 may be moved relative to a platform (or vice versa or both the hot end 124 and the platform may be moved relative to one another) to deposit the molten material at desired locations where the molten material may then cool and solidify to form the object. The extruder 120 may remain in a fixed location during operation of the 3D printer 100 and the Bowden tube 128 and the filament 130 may flex and bend to accommodate the movement of the hot end 124 relative to the extruder 120.

FIG. 2 is a schematic of a portion of a 3D printer 200 including a direct extrusion hot end system 202 including an extruder driver gear 210 comprising a superhard material, according to an embodiment. The 3D printer 200 may include direct extruder hot end system 202 that includes an extruder 220, a heater 234, and a nozzle 236. Optionally, the 3D printer 200 may include a filament guide tube 228, which may be similar to a Bowden tube, which may guide a filament 230 from a reel (not shown) to the extruder 220. The extruder 220 may include a motor (not shown), such as a stepper motor, an extruder driver gear 210, and an idler 222. A hub of the extruder driver gear 210 may be mounted to a drive shaft 226 of the motor such that the motor may selectively apply a torque to the extruder driver gear 210 to cause the selective rotation of the extruder driver gear 210.

Within the extruder 220, a portion of the filament 230 may be positioned between the idler 222 and the extruder driver gear 210 (e.g., which may each include a superhard material as discussed in further detail herein with reference to FIGS. 3-10) that may grip or engage the filament 130. The idler 222 may be a relatively smooth wheel that may be mounted on a bearing to allow the idler 222 to rotate freely. The idler 222 may be positioned proximate to the extruder driver gear 210 such that the idler 222 may press the portion of the filament 230 that is located between the idler 222 and the extruder driver gear 210 toward the extruder driver gear 210 and maintain contact and pressure (or force) between the filament 230 and the extruder driver gear 210. Optionally, the idler 222 may be biased towards the extruder driver gear with a biasing element, such as a spring, such that various diameters of filament 230 may be accommodated.

When the 3D printer 200 requires material for forming an object, the motor may be activated and apply a torque to the extruder driver gear 210 and cause the extruder driver gear 210 to rotate. Filament gripping teeth of the extruder driver gear 210 may grip or engage the outer surface of the filament 230 and cause the filament to advance through the extruder 220 and into the heater 234 in response to the rotation of the extruder driver gear 210. The end of the filament 230 may then be melted by the heater 234 and the resulting molten material may be pushed out of the nozzle 236 with pressure being applied to the molten material by the filament 230 being fed into the heater 234 by the extruder driver gear 210 of the extruder 220.

As the molten material exits the nozzle 236, the direct extrusion hot end system 202 may be moved relative to a platform to deposit the molten material at desired locations where the molten material may cool and solidify to form the object. Accordingly, the extruder 220 may move along with the direct extrusion hot end system 202 during operation of the 3D printer 200.

FIG. 3 is an isometric view of an extruder driver gear 310 comprising a superhard material, according to an embodiment. The extruder driver gear 310 may include a hub 340, a gear body 344, and a plurality of filament gripping teeth 348 arranged around an axis of rotation 350. The hub 340 may be centrally located on the extruder driver gear 310 and configured for coupling to a torque transmitting component of an extruder.

For example, the hub 340 may include a central aperture (see, e.g., central aperture 460, 554 of FIGS. 4 and 5) extending along the axis of rotation 350 from a first end 352 of the extruder driver gear 310 into the hub 340. The central aperture may be sized and shaped to receive a drive shaft of a motor, such as a stepper motor, and positioned to align an axis of rotation of the drive shaft with the axis of rotation 350 of the extruder driver gear 310. The hub 340 may include a securing feature, such as a threaded aperture 354 configured to receive a set screw extending from a side surface 356 of the extruder driver gear 310 to the central aperture, which may be utilized to secure a drive shaft within the central aperture. In additional embodiments, the hub 340 may include securing features such as a keyway sized and positioned to receive a key to secure a drive shaft within the central aperture of the hub 340.

The gear body 344 may be connected to the hub 340, and the plurality of filament gripping teeth 348 may extend radially from the gear body 344. Each of the plurality of filament gripping teeth 348 may be wedge shaped with a base attached to the gear body 344 and narrowing to a radially outer edge. In some embodiments, each of the plurality of filament gripping teeth 348 may be oriented parallel to the axis of rotation 350. In additional embodiments, the plurality of filament gripping teeth 348 may be oriented at an angle relative to the axis or rotation 350 or may have a helical shape relative to the axis of rotation 350. In yet further embodiments, the plurality of filament gripping teeth 348 may be oriented in a chevron pattern.

The plurality of filament gripping teeth 348 may comprise one or more superhard material (e.g., PCD, PCBN, silicon carbide, or any material having a hardness exceeding the hardness of tungsten carbide) and/or may comprise or be formed entirely from a superhard material. For example, the plurality of filament gripping teeth 348 may be formed entirely from PCD. For another example, the plurality of filament gripping teeth 348 may be formed entirely from PcBN.

In view of the foregoing, extruder driver gears 310 having filament gripping teeth 348 comprising superhard material according to embodiments disclosed herein may be improved over existing extruder driver gears. For example, extruder driver gears having filament gripping teeth comprising superhard material according to embodiments disclosed herein may have improved resistance to wear and may maintain their shape over many use cycles, and thus maintain engagement between the extruder driver gear and the filament. Accordingly, slipping of the filament relative to the extruder driver gear and underfeeding of the material to a hot end may be eliminated or reduced significantly, and thus time consuming and costly maintenance of the extruder, material waste, and/or 3D printer downtime may also be reduced or eliminated.

In some embodiments, due to the strength and wear resistance of the filament gripping teeth 348 comprising superhard material, the size and weight of the extruder driver gears 310 according to embodiments disclosed herein may be relatively small. For example, an outer diameter of the gear body 344 may be less than or equal to three times the diameter of a filament for which the extruder driver gear 310 is intended to grip. For another example, an outer diameter of the gear body 344 may be less than or equal to another multiple of the diameter of a filament (e.g., ten times the diameter, eight times the diameter, six times the diameter, four times the diameter, twice the diameter) for which the extruder driver gear 310 is intended to grip or move. For yet another example, an outer diameter of the gear body 344 may be less than or equal to the diameter of a filament for which the extruder driver gear 310 is intended to grip or move.

A reduction in the size of the extruder driver gear may facilitate a reduction in the size and weight of the extruder which may improve printing speed, and printing accuracy of the object that is being formed. This may be especially relevant for 3d printing systems with a direct extrusion hot end system, where the extruder may be moved with the hot end during printing. Reducing the weight of the hot end may reduce the inertia of the hot end and reduce oscillation and other unintended motion of the hot end during printing operations, which may improve speed and accuracy.

FIG. 4 is a cross-sectional view of an assembled extruder driver gear 410 having a gear body 444 and a plurality of filament gripping teeth 448 made from a superhard material, according to an embodiment. The extruder driver gear 410 may be like the extruder driver gear 310 described with reference to FIG. 3, and may similarly include a hub 440, a gear body 444, and a plurality of filament gripping teeth 448 arranged around an axis of rotation 450. The hub 440 may be centrally located on the extruder driver gear 410 and include an aperture 460 configured for coupling to a torque transmitting component of an extruder, such as a drive shaft.

The gear body 444 and the plurality of filament gripping teeth 448 may be formed as a single monolithic structure that comprises one or more superhard material and/or may be formed entirely from a superhard material, that may be coupled with the hub 440. Accordingly, the gear body 444, and the plurality of filament gripping teeth 448, may be formed entirely from at least one of polycrystalline diamond, polycrystalline cubic boron nitride, and silicon carbide.

In some embodiments, the hub 440 may be formed separately from the gear body 444 and then the gear body 444 may be connected to the hub 440. For example, the gear body 444 may be connected to the hub 440 by at least one of solder, braze, an adhesive, and a mechanical connection. Examples of a mechanical connection include a press fit and/or a fastener, such as a bolt.

In additional embodiments, the hub 440 and gear body 444 may be formed from a precursor structure that comprises a superhard material portion that is formed into the gear body 444 and another material portion, such as a tungsten carbide portion, that is formed into the hub 440.

Accordingly, in some embodiments the hub 440 may be comprised of a metal. In some embodiments, the hub 440 may be comprised of at least one of tungsten carbide, a nickel-iron alloy (e.g., Invar), steel, and brass. In additional embodiments, the extruder driver gear, including the hub, the gear body, and the plurality of filament gripping teeth, may be formed entirely from at least one of a cemented carbide substrate bonded to polycrystalline cubic boron nitride or a cemented carbide substrate bonded to polycrystalline diamond.

FIG. 5 is a cross-sectional view of a monolithic extruder driver gear 510 that is entirely made from a superhard material, according to an embodiment. The extruder driver gear 510 may be like the extruder driver gear 310 described with reference to FIG. 3, and may similarly include a hub 540, a gear body 544, and a plurality of filament gripping teeth 548 arranged around an axis of rotation 550. The hub 540 may be centrally located on the extruder driver gear 510 and include an aperture 560 configured for coupling to a torque transmitting component of an extruder, such as a drive shaft.

The extruder driver gear 510 may be a monolithic structure that is formed entirely from at least one superhard material. Accordingly, the hub 540, the gear body 544, and the plurality of filament gripping teeth 548 may be formed entirely from at least one of polycrystalline diamond, polycrystalline cubic boron nitride, tungsten carbide, and/or silicon carbide.

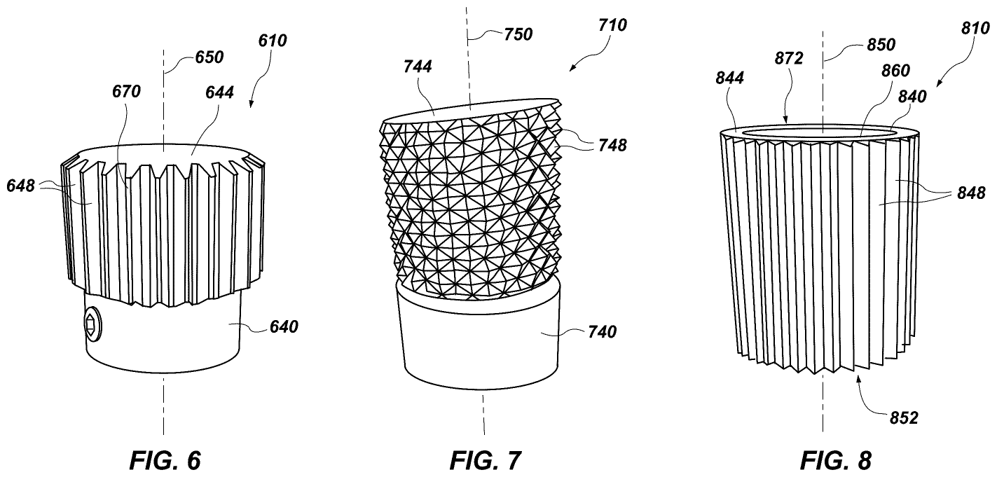

FIG. 6 is an isometric view of an extruder driver gear 610 comprising a superhard material and wherein each filament gripping tooth 648 comprises a top land 670, according to an embodiment. The extruder driver gear 610 may be like the extruder driver gear 310 described with reference to FIG. 3, and may similarly include a hub 640, a gear body 644, and a plurality of filament gripping teeth 648 arranged around an axis of rotation 650, the plurality of filament gripping teeth 648 comprising a superhard material.

Each of the plurality of filament gripping teeth 648 may be substantially wedge shaped with a base attached to the gear body 644 and narrowing to a top land 670 located at a radially outer edge. The transition between the sides of each tooth 648 and the top land 670 may be relatively sharp, as shown, or may include a small radius. By having a top land 670, rather than a relatively sharp leading edge, the plurality of filament gripping teeth 648 may be easier to manufacture. Additionally, having a top land 670, rather than a relatively sharp leading edge, may reduce stress concentrations at the edge of each of the plurality of filament gripping teeth 648. Accordingly, an extruder driver gear 610 with a plurality of filament gripping teeth 648 each comprising a top land 670 may be desirable for use with particularly hard filament material and/or in cases where a relatively high pressure is applied between the filament and the extruder driver gear 610.

In some embodiments, each of the plurality of filament gripping teeth 648 may be oriented parallel to the axis of rotation 650. In additional embodiments, the plurality of filament gripping teeth 648 may be oriented at an angle relative to the axis or rotation or may have a helical shape relative to the axis of rotation 650. In yet further embodiments, the plurality of filament gripping teeth 648 may be oriented in a chevron pattern.

FIG. 7 is an isometric view of an extruder driver gear 710 comprising a superhard material and with pyramidal filament gripping teeth, according to an embodiment. The extruder driver gear 710 may be like the extruder driver gear 310 described with reference to FIG. 3, and may similarly include a hub 740, a gear body 744, and a plurality of filament gripping teeth 748 arranged around an axis of rotation 750, the plurality of filament gripping teeth 748 comprising a superhard material.

Each of the plurality of filament gripping teeth 748 may be pyramidal shaped with a base attached to the gear body 744 and narrowing to a relatively sharp point located at a radially outer edge. For example, the plurality of filament gripping teeth 748 may have the shape and appearance of a knurled surface. By having relatively sharp points, rather than a relatively sharp leading edge, the plurality of filament gripping teeth 748 may have improved surface penetration into a filament, thus improving the grip and/or movement of the filament. Accordingly, an extruder driver gear 710 with a plurality of filament gripping teeth 748 each comprising a relatively sharp point may be desirable for use in cases where additional grip or engagement of the filament is desired and/or a relatively low pressure is applied between the filament and the extruder driver gear 710.

FIG. 8 is an isometric view of an extruder driver gear 810 with a hub contained within the gear body comprising a superhard material, according to an embodiment. The extruder driver gear 810 may be like the extruder driver gear 310 described with reference to FIG. 3, and may similarly include a hub 840, a gear body 844, and a plurality of filament gripping teeth 848 arranged around an axis of rotation 850, the plurality of filament gripping teeth 848 comprising a superhard material.

An aperture 860 of the hub 840 of the extruder driver gear 810 may extend through the entire length of the extruder driver gear 810 from a first end 852 to a second end 872. Accordingly, the extruder driver gear 810 may be configured to be received on a shaft, such as a drive shaft of a motor, such that the shaft may extend through the extruder driver gear 810, which may provide improved stability as the shaft on which the extruder driver gear 810 is mounted may be supported at both ends.

Likewise, the plurality of filament gripping teeth 848 may extend along the entire length of the extruder driver gear 810 from the first end 852 to the second end 872. Accordingly, there may not be a clear geometric delineation between the hub 840 and the gear body 844. Like the extruder driver gear 310 described with reference to FIG. 3, each of the plurality of filament gripping teeth 848 may be wedge shaped with a base attached to the gear body 844 and narrowing to a radially outer edge. Each of the plurality of filament gripping teeth 848 may be oriented parallel to the axis of rotation 850. In additional embodiments, the plurality of filament gripping teeth 848 may be oriented at an angle relative to the axis or rotation 850 or may have a helical shape relative to the axis of rotation 850. In yet further embodiments, the plurality of filament gripping teeth 848 may be oriented in a chevron pattern.

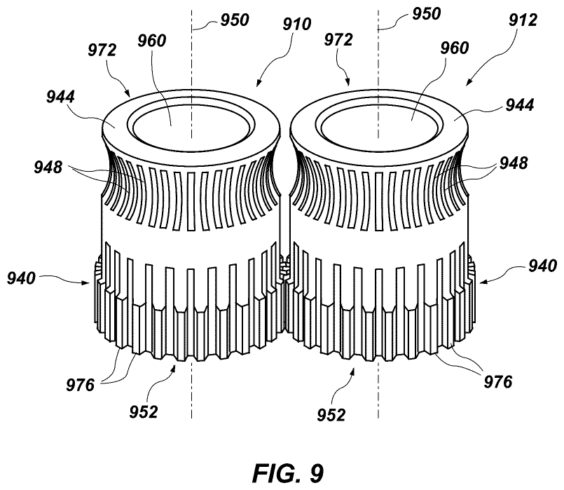

FIG. 9 is an isometric view of a set of extruder driver gears 910, 912 with curved filament gripping teeth 948 comprising a superhard material and a hub 940 comprising intermeshing torque transmission gears 976, according to an embodiment. The extruder driver gears 910, 912 may be similar to the extruder driver gear 310 described with reference to FIG. 3, and may similarly include a hub 940, a gear body 944, and a plurality of filament gripping teeth 948 arranged around an axis of rotation 950, the plurality of filament gripping teeth 948 comprising a superhard material. The extruder driver gears 910, 912 may additionally include intermeshing torque transmission gears 976 that may facilitate the transmission of torque from one extruder driver gear 910 to the other extruder driver gear 912, and optionally from a torque transmission gear coupled to a motor to one of the extruder driver gears 910, 912.

Each of the plurality of filament gripping teeth 948 may be wedge shaped with a base attached to the gear body 944 and narrowing to a radially outer edge. Additionally, the plurality of filament gripping teeth 948 may each comprise a curved edge (e.g., an arcuate distal side) shaped to conform to the shape of a filament, which may provide increased surface contact between the plurality of filament gripping teeth 948 and the filament.

Like the extruder driver gear 810, an aperture 960 may extend through the entire length of each of the extruder driver gears 910, 912 from a first end 952 to a second end 972. Accordingly, each extruder driver gear 910, 912 may be configured to be received on a shaft such that the shaft may extend through the extruder driver gear 910, 912, which may provide improved stability as the shaft on which the extruder driver gear 910, 912 is mounted may be supported at both ends. In some embodiments, one extruder driver gear 910 may be mounted on a drive shaft of a motor and the other extruder driver gear 912 may be mounted on an idler shaft that may freely rotate.

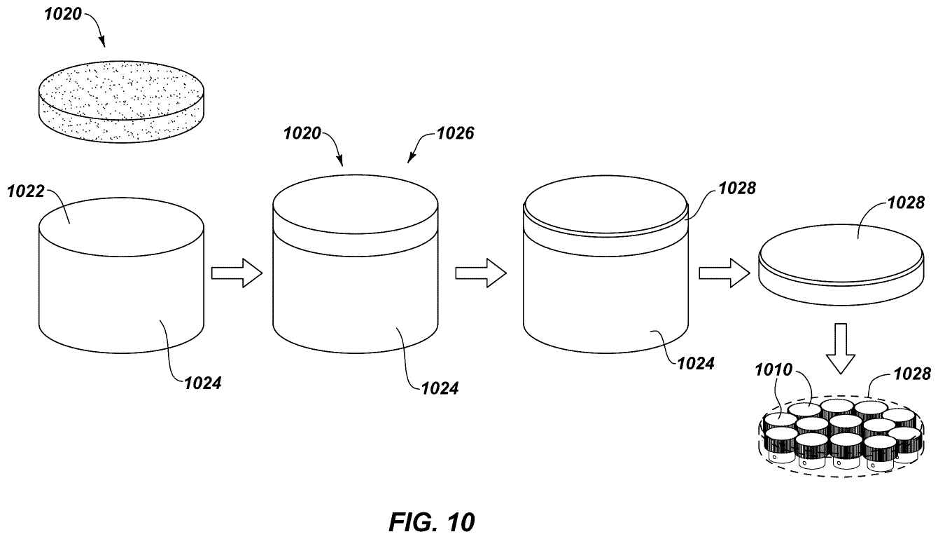

FIG. 10 is a schematic illustration of a method for fabricating extruder driver gears 1010 from polycrystalline diamond, according to an embodiment. It is noted that the extruder driver gears 1010 may be any of the extruder driver gears disclosed herein. The method may include forming a precursor structure comprising a superhard material, and removing a portion of the superhard material from the precursor structure to form a gear body having a plurality of filament gripping teeth extending from the gear body, the plurality of filament gripping teeth comprising the superhard material.

Referring to FIG. 10, a mass of diamond particles 1020 may be provided. The diamond particles 1020 may exhibit an average particle size of about 50 μm or less, such as about 40 μm or less, about 30 μm or less, about 20 μm or less, about 10 μm to about 18 μm, or about 15 μm to about 18 μm. In some embodiments, the average particle size of the diamond particles 1020 may be about 10 μm or less, such as about 2 μm to about 5 μm or submicron.

In an embodiment, the diamond particles 1020 may comprise a relatively larger size and at least one relatively smaller size. As used herein, the phrases “relatively larger” and “relatively smaller” refer to particle sizes (by any suitable method) that differ by at least a factor of two (e.g., 30 μm and 15 μm). According to various embodiments, the mass of diamond particles 1020 may include a portion exhibiting a relatively larger size (e.g., 30 μm, 20 μm, 15 μm, 12 μm, 10 μm, 8 μm) and another portion exhibiting at least one relatively smaller size (e.g., 6 μm, 5 μm, 4 μm, 3 μm, 2 μm, 1 μm, 0.5 μm, less than 0.5 μm, 0.1 μm, less than 0.1 μm). In one embodiment, the mass of diamond particles 1020 may include a portion exhibiting a relatively larger size between about 10 μm and about 40 μm and another portion exhibiting a relatively smaller size between about 1 μm and 4 μm. In some embodiments, the mass of diamond particles 1020 may comprise three or more different sizes (e.g., one relatively larger size and two or more relatively smaller sizes), without limitation. It is noted that the as-sintered diamond grain size may differ from the average particle size of the mass of diamond particles prior to sintering due to a variety of different physical processes, such as grain growth, diamond particles fracturing, carbon provided from another carbon source (e.g., dissolved carbon in the metal-solvent catalyst), or combinations of the foregoing.

The mass of diamond particles 1020 may be positioned adjacent to the interfacial surface 1022 of the substrate 1024 to form an assembly 1026. The substrate 1024 may include, without limitation, cemented carbides, such as tungsten carbide, titanium carbide, chromium carbide, niobium carbide, tantalum carbide, vanadium carbide, or combinations thereof cemented with iron, nickel, cobalt, or alloys thereof. For example, in one embodiment, the substrate 1024 comprises cobalt-cemented tungsten carbide. The substrate 1024 may be generally cylindrical or another configuration, without limitation. Although an interfacial surface 1022 of the substrate 1024 is shown as being substantially planar, the interfacial surface 1022 may exhibit a selected nonplanar topography, such as a grooved, ridged, or other nonplanar interfacial surface.

The assembly 1026 may also include a catalyst configured to sinter the mass of diamond particles 1020. The catalyst may be provided in particulate form mixed with the mass of diamond particles 1020, as a thin foil or plate placed adjacent to the mass of diamond particles 1020, from the substrate 1024 (e.g., the substrate 1024 is a cemented carbide substrate including a metal-solvent catalyst), or combinations thereof. In an embodiment, the catalyst includes a metal-solvent catalyst (e.g., iron, nickel, cobalt, or alloys thereof). In an embodiment, the catalyst includes at least one nonmetallic catalyst selected from one or more of alkali metal carbonate (e.g., one or more carbonates of Li, Na, and K), one or more alkaline earth metal carbonates (e.g., one or more carbonates of Be, Mg, Ca, Sr, and Ba), a sulfate (e.g., one or more sulfates of Be, Mg, Ca, Sr, and Ba), a hydroxide (e.g., one or more hydroxides of Be, Mg, Ca, Sr, and Ba), elemental phosphorous and/or a derivative thereof, a chloride (e.g., one or more chlorides of Li, Na, and K), elemental sulfur and/or a derivative thereof, a polycylic aromatic hydrocarbon (e.g., naphthalene, anthracene, pentacene, perylene, coronene, or combinations of the foregoing) and/or a derivative thereof, a chlorinated hydrocarbon and/or a derivative thereof, a semiconductor material (e.g., germanium or a geranium alloy), and combinations of the foregoing. In an example, the catalyst includes one or more metal-solvent catalysts and one or more nonmetallic catalysts.

In order to efficiently sinter the mass of diamond particles 1020, the assembly 1026 may be enclosed in a pressure transmitting medium, such as a refractory metal can, graphite structure, pyrophyllite, and/or other suitable pressure transmitting structure to form a cell assembly. Examples of suitable gasket materials and cell structures for use in manufacturing PCD are disclosed in U.S. Pat. Nos. 6,338,754 and 8,236,074, each of which is incorporated herein, in its entirety, by this reference. Another example of a suitable pressure transmitting material is pyrophyllite, which is commercially available from Wonderstone Ltd. of South Africa.

The cell assembly 1026, including the pressure transmitting medium and mass of diamond particles 1020 therein, may be subjected to a high-pressure and high-temperature (HPHT) process using an ultra-high pressure press at a temperature of at least about 1000° C. (e.g., about 1100° C. to about 2200° C., or about 1200° C. to about 1450° C.) and a pressure in the pressure transmitting medium of at least about 5 GPa (e.g., about 7.5 GPa to about 15 GPa, at least about 8.0 GPa, at least about 9.0 GPa, at least about 10.0 GPa, at least about 11.0 GPa, at least about 12.0 GPa, or at least about 14 GP) for a time sufficient to sinter the diamond particles 1020 together in the presence of the catalyst and form the PCD table 1028 comprising bonded diamond grains defining interstitial regions occupied by the catalyst. The HPHT process may form a PCD compact 1070 that includes the PCD table 1028 bonded to the substrate during the HPHT process, the catalyst may liquefy and, if the catalyst is disposed outside the diamond particles 1020, the catalyst may infiltrate the mass of diamond particles 1020. The catalyst promotes growth between adjacent diamond particles of the mass of diamond particles 1020 to form the PCD table 1028 comprised of a body of bonded diamond grains having the infiltrated catalyst interstitially disposed between bonded diamond grains. For example, if the substrate 1024 is a cobalt-cemented tungsten carbide substrate, cobalt from the substrate 1024 may be liquefied and infiltrate the mass of diamond particles 1020 to catalyze formation of the PCD table 1028.

The pressure values employed in the HPHT processes disclosed herein refer to the pressure in the pressure transmitting medium at room temperature (e.g., about 25° C.) with application of pressure using an ultra-high-pressure press and not the pressure applied to exterior of the cell assembly 1026. The actual pressure in the pressure transmitting medium at sintering temperature may be slightly higher. The ultra-high-pressure press may be calibrated at room temperature by embedding at least one calibration material that changes structure at a known pressure, such as PbTe, thallium, barium, or bismuth in the pressure transmitting medium. Further, optionally, a change in resistance may be measured across the at least one calibration material due to a phase change thereof. For example, PbTe exhibits a phase change at room temperature at about 6.0 GPa and bismuth exhibits a phase change at room temperature at about 7.7 GPa. Examples of suitable pressure calibration techniques are disclosed in G. Rousse, S. Klotz, A. M. Saitta, J. Rodriguez-Carvajal, M. I. McMahon, B. Couzinet, and M. Mezouar, “Structure of the Intermediate Phase of PbTe at High Pressure,” Physical Review B: Condensed Matter and Materials Physics, 71, 224116 (2005) and D. L. Decker, W. A. Bassett, L. Merrill, H. T. Hall, and J. D. Barnett, “High-Pressure Calibration: A Critical Review,” J. Phys. Chem. Ref. Data, 1, 3 (1972).

In other embodiments, a PCD table 1028 according to an embodiment may be separately formed using an HPHT sintering process and, subsequently, bonded to the interfacial surface 1022 of the substrate 1024 by brazing, using a separate HPHT bonding process, or any other suitable joining technique, without limitation. In yet another embodiment, a substrate 1024 may be formed by depositing a binderless carbide (e.g., tungsten carbide) via chemical vapor deposition onto the separately formed PCD table 1028.

In any of the embodiments disclosed herein, substantially all or a selected portion of the catalyst (e.g., metal-solvent catalyst) may be removed (e.g., via leaching) from the PCD table 1028. In an embodiment, metal-solvent catalyst in the PCD table 1028 may be removed to a selected depth from at least one exterior working surface (e.g., the working surface and/or a sidewall working surface of the PCD table 1028) so that only a portion of the interstitial regions are occupied by metal-solvent catalyst. For example, substantially all or a selected portion of the metal-solvent catalyst may be removed from the PCD table 1028 so-formed in the PDC 1028 to a selected depth from the working surface. Leaching the catalyst from the PCD table 1028 may improve the thermal stability of the extruder driver gears 1010 formed from the PCD table 1028. For example, leaching the catalyst from the PCD table 1028 may allow the PCD table to be brazed to the base and/or heated to temperatures of about or greater than 700° C. substantially without thermal degradation. In some embodiments, the catalyst may not be leached from the PCD table 1028. In some embodiments, the catalyst may only be leached from a portion of the PCD table, thereby increasing the thermal stability of the extruder driver gears 1010 formed therefrom.

In another embodiment, a PCD table 1028 may be fabricated according to any of the disclosed embodiments in a first HPHT process, leached to remove substantially all of the metal-solvent catalyst from the interstitial regions between the bonded diamond grains, and subsequently bonded to a substrate in a second HPHT process. In the second HPHT process, an infiltrant from, for example, a cemented carbide substrate may infiltrate into the interstitial regions from which the metal-solvent catalyst was depleted. For example, the infiltrant may be cobalt that is swept-in from a cobalt-cemented tungsten carbide substrate. In one embodiment, the first and/or second HPHT process may be performed at a pressure of at least about 7.5 GPa. In one embodiment, the infiltrant may be leached from the infiltrated PCD table 1028 using a second acid leaching process following the second HPHT process.

In an embodiment, the PCD table 1028 may be a binderless PCD table. The binderless PCD table may be formed by pressing a mass of diamond particles with or without additives such as a catalyst. The diamond particles are pressed without any metal-solvent catalyst being present. For example, the mass of diamond particles may not be disposed on a cobalt-cemented tungsten carbide substrate. The binderless PCD table may be pressed using any of the pressures and temperatures disclosed herein.

In an embodiment, as shown, the substrate 1024 may be removed or otherwise detached from the PCD table 1028. For example, the substrate 1024 may be removed from the PCD table 1028 by grinding the substrate 1024 or dissolving the substrate 1024 in an acid. In an embodiment, not shown, at least a portion of the substrate 1024 may not be removed or otherwise detached from the PCD table 1028. In such an embodiment, the substrate 1024 may form a part of the extruder driver gear(s) formed from the PCD table 1028.

The PCD table 1028, and optionally, the substrate 1024, may be utilized as a precursor structure to form one or more driver gears. Portions of the PCD table 1028 and, optionally, the substrate 1024, may be removed to form one or more extruder driver gears 1010. For example, portions of the PCD table 1028 and, optionally, the substrate 1024 may be removed (e.g., via laser ablation) to form 1, 2, 3, 4, 5, 6, 7, 8, 9, 10, 11, 12, 13, 14, 15, 16, 17, 18, 19, 20, or greater than 20 extruder driver gears 1010. The number of extruder driver gears 1010 formed from the PCD table 1028 and, optionally, the substrate 1024 may depend on the size (e.g., maximum lateral dimension, thickness, and volume) of the PCD table 1028, the shape of the PCD table 1028, whether the substrate 1024 forms a portion of the extruder driver gears 1010, the size of the extruder driver gears 1010, and the shape of the extruder driver gears 1010. It is noted that the extruder driver gears 1010 formed from the PCD table 1028 and, optionally, the substrate 1024 may include one or more feature that is the same or substantially similar to any of the one or more feature of the extruder driver gears disclosed herein, without limitation.

In an embodiment, the portions of the PCD table 1028 and, optionally, the substrate 1024 may be removed using a laser. In such an embodiment, the laser may emit a plurality of laser pulses towards one or more surfaces of the PCD table 1028 and, optionally, the substrate 1024. The laser pulses may be selected to remove the PCD table 1028 in one or more layers. The laser ablation process may accomplish at least one of the following: form a plurality of extruder driver gears 1010 from the PCD table 1028 (e.g., simultaneously or substantially simultaneously), form the exterior features (e.g., top surface, bottom surface, lateral surface, etc.), form interior features (e.g., aperture) of the extruder driver gear 1010, or polish the surfaces of the extruder driver gears 1010. Examples of lasing methods that may be used to remove portions of the PCD table 1028 and/or substrate 1024 are disclosed in U.S. patent application Ser. No. 16/084,469 filed on Jan. 10, 2018, published as U.S. Application Publication US 2019/0084087 A1, the disclosure of which is incorporated herein, in its entirety, by this reference.

In an embodiment, the portions of the PCD table 1028 and, optionally, the substrate 1024 may be removed using one or more of grinding, lapping, electrical discharge machining (e.g., wire electrical discharge machining), or any other machining technique. Unlike lasing, some machining techniques such as grinding, lapping, and electrical discharge machining may at least one of exhibit high wear due to the hardness of diamond, may be unable to form all of the extruder driver gears 1010 collectively (e.g., in a single process), form both the exterior and interior features of the extruder driver gears 1010, or polish the surfaces of the extruder driver gears 1010. In an embodiment, the portions of the PCD table 1028 and, optionally, the substrate 1024 may be removed using lasing and one or more of grinding, lapping, electrical discharge machining, or any other machining technique.

As previously discussed, the extruder driver gears disclosed herein may be at least partially formed from PcBN instead of or in addition to PCD. More generally, extruder driver gears disclosed herein may comprise one or more superhard material (e.g., PCD, PCBN, silicon carbide, or any material having a hardness exceeding the hardness of tungsten carbide), without limitation. For example, the extruder driver gear may comprise PcBN due the hardness and thermal conductivity of PcBN, which is comparable to the hardness and thermal conductivity of PCD. The extruder driver gear formed from PcBN may decrease the wear on the extruder driver gear, may increase the lifespan of the extruder driver gear, and may allow the extruder driver gear to be used with abrasive printing materials.

In an embodiment, all of the extruder driver gear may be formed from PcBN. Forming all of the extruder driver gear from PcBN may make manufacturing the extruder driver gear easier since there is no need to attach the PcBN to another material and improve the wear characteristics of the extruder driver gear. In another embodiment, only a portion of the extruder driver gear comprises PcBN. Manufacturing only a portion of the extruder driver gear from PcBN may make shaping and machining the extruder driver gear easier since the other materials of the extruder driver gear may be less hard than the PcBN. However, forming only a portion of the extruder driver gear from PcBN may require bonding the PcBN to another material, thereby increasing the complexity of manufacturing the extruder driver gear. Also, the fact that portions of the extruder driver gear are formed from a less hard material than PcBN may increase wear on portions of the extruder driver gear that are formed from the less hard material thereby decreasing the lifespan of the extruder driver gear.

The PcBN may be formed by heating boron nitride at any of the same temperatures and pressures discussed above, such as a temperature of about 1000° C. to about 1450° C. and a pressure of about 5 GPa to about 14 GPa. Catalysts for PcBN include, for example, alkali metals, antimony, lead, tin, lithium, magnesium, and nitrides. After forming the PcBN, one or more extruder driver gears may be formed therefrom using the same techniques disclosed above with regards to PCD. For example, the extruder driver gears may be formed by lasing, grinding, lapping, electrical discharge machining, or any other suitable machining technique.

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall have the same meaning as the word “comprising” and variants thereof (e.g., “comprise” and “comprises”).

Terms of degree (e.g., “about,” “substantially,” “generally,” etc.) indicate structurally or functionally insignificant variations. In an example, when the term of degree is included with a term indicating quantity, the term of degree is interpreted to mean ±10%, ±5%, ±2%, or even 0% of the term indicating quantity. In an example, when the term of degree is used to modify a shape, the term of degree indicates that the shape being modified by the term of degree has the appearance of the disclosed shape. For instance, the term of degree may be used to indicate that the shape may have rounded corners instead of sharp corners, curved edges instead of straight edges, one or more protrusions extending therefrom, is oblong, is the same as the disclosed shape, etc.

What is claimed is:

1. An extruder driver gear comprising:
a hub configured for coupling to a torque transmitting component;
a gear body connected to the hub; and
a plurality of filament gripping teeth extending radially from the gear body, the plurality of filament gripping teeth comprising a superhard material.

2. The extruder driver gear of claim 1, wherein the hub is configured for attachment to the torque transmitting component of an extruder of a three-dimensional (3D) printer.

3. The extruder driver gear of claim 1, wherein the plurality of filament gripping teeth are formed entirely from at least one of polycrystalline diamond, polycrystalline cubic boron nitride, or silicon carbide.

4. The extruder driver gear of claim 1, wherein the extruder driver gear, including the hub, the gear body, and the plurality of filament gripping teeth, is a monolithic structure formed entirely from at least one of polycrystalline diamond, polycrystalline cubic boron nitride, or silicon carbide.

5. The extruder driver gear of claim 1, wherein the extruder driver gear, including the hub, the gear body, and the plurality of filament gripping teeth, is formed entirely from at least one of cemented carbide substrate bonded to polycrystalline cubic boron nitride or cemented carbide substrate bonded to polycrystalline diamond.

6. The extruder driver gear of claim 1, wherein the gear body is connected to the hub by at least one of solder, braze, an adhesive, or a mechanical connection.

7. The extruder driver gear of claim 1, wherein the hub is comprised of a metal.

8. The extruder driver gear of claim 1, wherein the hub is comprised of at least one of tungsten carbide, nickel-iron alloy, steel, or brass.

9. The extruder driver gear of claim 1, wherein an outer diameter of the gear body is less than or equal to ten times the diameter of a filament for which the extruder driver gear is intended to grip.

10. The extruder driver gear of claim 1, wherein the plurality of filament gripping teeth are each wedge shaped.

11. The extruder driver gear of claim 1, wherein the plurality of filament gripping teeth each comprise a curved edge shaped to conform to the shape of a filament.

12. The extruder driver gear of claim 1, wherein the plurality of filament gripping teeth each include a top land.

13. The extruder driver gear of claim 1, wherein the plurality of filament gripping teeth are each pyramidal shaped.

14. The extruder driver gear of claim 1, wherein the hub comprises a torque transmission gear.

15. A method of manufacturing an extruder driver gear, the method comprising:
forming a precursor structure comprising a superhard material; and
removing a portion of the superhard material from the precursor structure to form a gear body having a plurality of filament gripping teeth extending from the gear body, the plurality of filament gripping teeth comprising the superhard material.

16. The method of claim 15, wherein forming the precursor structure comprising the superhard material comprises forming a polycrystalline diamond precursor structure.

17. The method of claim 15, wherein forming the precursor structure comprising the superhard material comprises forming a polycrystalline cubic boron nitride precursor structure.

18. The method of claim 15, wherein removing the portion of the superhard material from the precursor structure comprises laser ablation of the portion of the superhard material.

19. The method of claim 15, further comprising forming a hub and coupling the hub to the gear body.

20. A three-dimensional printer comprising:
a hot end configured to melt a filament; and
an extruder configured to feed the filament into the hot end, the extruder comprising:
a motor; and
an extruder driver gear coupled to the motor, the extruder driver gear comprising a plurality of filament gripping teeth comprising a superhard material.
